(19) United States
(12) Patent Application Publication
(10) Pub. No.: US 2006/0101492 A1
(43) Pub. Date: May 11, 2006

(54) Mobile television reminder alert

(76) Inventor: Joshua Peter Mark Lowcock, Artarmon (AU)

Correspondence Address: ARENT FOX PLLC, 1050 CONNECTICUT AVENUE, N.W., SUITE 400, WASHINGTON, DC, 20036, US

(21) Appl. No.: 10/531,239

(22) PCT Filed: Oct. 14, 2003
(86) PCT No.: PCT/AU03/01354

§ 371 Date: Aug. 15, 2005

(30) Foreign Application Priority Data
Oct. 18, 2002 (AU) 2002952173

(51) Int. Cl. H04N 5/445

(52) U.S. Cl. 725/58

(57) ABSTRACT

The present invention discloses a reminder system for prospective viewers of broadcast television programmes. Those prospective viewers having access to a mobile phone (14) can send an SMS message via a public telephone network (16) and request a return SMS message be sent to their mobile phone (14) just prior to the broadcast commencing. The system and method can be modified to utilize emails, and/or fixed phone 1900 prefix services.

### FIELD OF THE INVENTION

The present invention relates to television and, in particular, to broadcast television services.

### BACKGROUND ART

The modern lifestyle is a busy one and many prospective viewers of a television programme have suffered from the frustration of suddenly looking at their watch and discovering that they have missed tne time of broadcast of a programme that they wished to watch. This is normally because they have been busy with some other activity and lost track of time. The programme which they have missed may be one for which they have seen a trailer—such as a documentary programme on a specific subject, or may be one which they wish to subsequently discuss with their peer group—such as a regular broadcast of a “soapie” or serial programme.

The present invention seeks to provide a system and method whereby such frustrations can be alleviated.

### SUMMARY OF THE INVENTION

In accordance with a first aspect of the present invention there is disclosed a broadcast television programme reminder system for prospective viewers each having, or having access to, a mobile phone, said system comprising a computer connected to a publicly accessible telephone service and adapted to receive SMS messages from said mobile phones, each of said messages requesting a reminder regarding a television programme to be broadcast at a future time, said computer including first storage means into which at least a portion of each said message is stored, and said computer further including a message originating means connected with said first storage means and adapted to send a reply SMS message to the corresponding mobile phone a predetermined time in advance of the future broadcast start time of said television programme for which a reminder had been requested.

In accordance with a second aspect of the present invention there is disclosed a method of providing requested reminders to prospective viewers of a broadcast television programme each having, or having access to, a mobile phone, said system comprising the steps of:

providing a computer connected to a publicly accessible telephone service, adapting said computer to receive SMS messages from said mobile phones, each of said messages requesting a reminder regarding a television programme to be broadcast at a future time,

providing said computer with first storage means and storing therein or at least a portion of each said received message,

providing said computer with a message originating means connected with said first storage means, and

sending a reply SMS message via said message originating means to said mobile phones a predetermined time in advance of the future time of said television programme for which a reminder had been requested.

### BRIEF DESCRIPTION OF THE DRAWINGS

Several embodiments of the present invention will now be described, by way of example only, with reference to the drawings in which:

FIG. 1 is a schematic representation of a prior art message system operable with the “set top box” required for cable TV systems, and

FIG. 2 is a schematic representation of preferred embodiment of the present invention.

### DETAILED DESCRIPTION

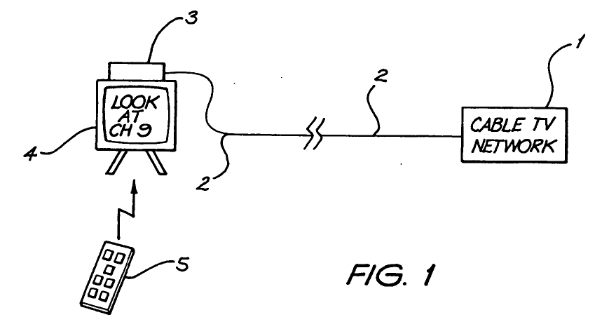

As seen in FIG. 1 a cable television network 1 is connected via a cable 2 to a set top box 3 which is connected to a television set 4 of a cable television subscriber. The subscriber can use a remote control device 5 to operate the television set 4 and set top box 3.

It is known to be able to insert into the set top box 3 by means of the control device 5, a request that a message be displayed at a particular time. Thus if the subscriber is watching channel 25, for example, the television set 4 displays a message such as “LOOK AT CHANNEL 9” at the appointed time. The intention of this prior art system is that a viewer can set a self alert and remind himself to watch a desired programme.

This prior art system suffers from a number of substantial disadvantages. Firstly, the reminder is only able to be perceived if the television set 4 is on. Thus if the subscriber happens to be gardening or otherwise not near the television set 4 at the time of the requested reminder, no reminder is created.

Second, provision is only made for a single reminder. Thus inserting a second reminder for a subsequent programme will overwrite an earlier reminder for an earlier, but not yet shown, programme. Therefore only the second reminder will appear, but not the first reminder also.

Thirdly, the reminder information stays in the set top box 3 and is not transferred to the cable TV network 1, so no statistical information about those programmes which viewers think are sufficiently important to warrant a reminder, can be gleaned, for example.

For all these reasons, the reminder system of FIG. 1 has not found commercial acceptance or even widespread technical comprehension in the television community in Australia.

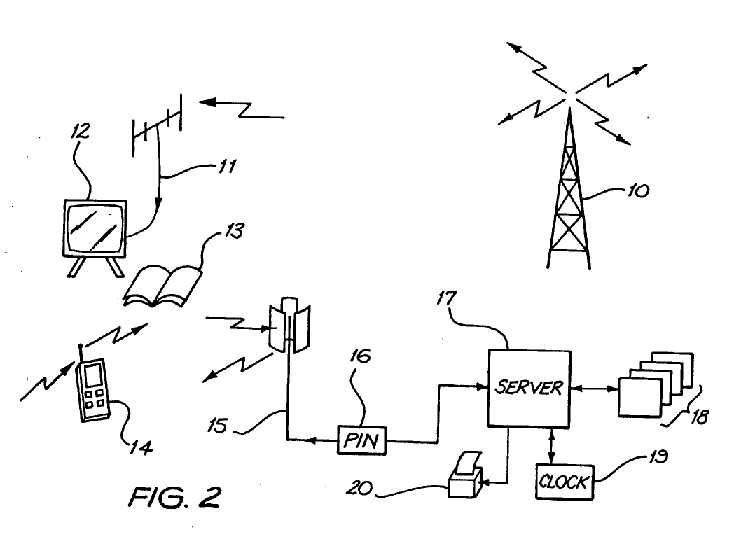

Turning now to FIG. 2, a conventional broadcast tower 10 transmits TV signals which are received by an aerial 11 of a TV set 12 of a viewer (not illustrated) who does not need to subscribe to any service. The viewer has access to a TV guide 13, which often is simply a newspaper but may be a purchased guide such as TV WEEK (Registered Trade Mark), and which publishes a unique G-code for each programme. Similarly, the G-code can be accessible to the viewer from a billboard or other publicly accessible source. Likewise, if the viewer has a WAP enabled or 3G mobile phone, for example, they can also selectively browse television program listings on the display of their mobile phones.

The G-code is intended to enable viewers to pre-set video recorders in advance of a broadcast time so that a viewer may record the broadcast programme which the viewer is unable to watch at the broadcast time. Thus the G-code is a number which encodes the date, channel, start time and end time of each programme to be broadcast. However, it is noted that in other embodiments, the G-code is replaced by any unique numeric or alpha-numeric code.

In the simplest embodiment of the present invention, the viewer uses his mobile phone 14 to send a SHORT MESSAGE SERVICE (SMS) message via a mobile phone tower 15 and public telephone network 16 to a server computer 17 operated by the provider of the reminder service. The SMS message includes at least the mobile telephone number of the mobile phone 14 and the G-code of the TV programme for which the reminder is desired. This data from each of a number of such messages is stored in a message storage bank 18 under control of the server 17.

The server 17 also includes a clock 19 and printer 20. At a predetermined time (say 5 minutes) before the broadcast start time, the clock 19 triggers the server 17 to send a reminder message as a return SMS message via the public telephone network 16 and tower 15 to the mobile phone 14. Since the mobile phone 14 will be carried by the viewer even when carrying out various activities such as gardening, the viewer will receive the return SMS message in good time to switch on the TV set 12 (if necessary) and watch the desired programme. Thus the abovementioned frustration is overcome.

Clearly, the viewer can send as many SMS messages as there are desired programmes for which he wishes to be reminded. Each such message is separately stored in the message storage bank 18 and results in a corresponding reminder return SMS message. Moreover, if the desired program is a serial where an episode is broadcast at the same time each week, for example, the computer can be configured to send SMS messages to the viewer in advance of the program being broadcast each week.

Further, at present return SMS messages which terminate at the originating mobile phone are “free” in the sense that the subscriber of the originating mobile phone pays for the originating call and that is the only charge. The operator of the PTN 16 is also, by negotiation, able to pay the operator of the reminder message service, a fee for all originating messages from mobile phones sent to the server 17. This is done by the PTN operator to encourage the reminder message operator to advertise the service and thus boost the volume of SMS messages sent.

It is known to provide “premium” billings for some types of mobile originating SMS messages. For example a charge of, say, A$0.30 per SMS message to the TV programme reminder message service may apply instead of the regular SMS message charge of, say, A$0.25. This premium is then able to be split between the PTN operator and the reminder message operator.

It is presently proposed that in future the cost of return SMS messages which terminate at an originating mobile phone, be charged to the subscriber of the originating mobile phone. Should this proposal be implemented it is not thought likely to disrupt the smooth operation of the above described system.

In addition, should a viewer so wish, rather than use a mobile phone, the viewer can telephone from a fixed phone and dial a 1900 premium service. At the appointed time the fixed phone receives a computer generated reminder phone call. Again the viewer/fixed phone subscriber is charged for this use by the telephone provider and a portion of this charge is remitted to the reminder message provider. Naturally, a reminder call to a fixed phone is not as convenient as a reminder message to a mobile phone, however, many fixed phone subscribers have radio base stations with mobile handsets which will permit incoming calls to be answered if the subscriber is working in the garden, laundry or garage, for example.

Furthermore, advertising is the lifeblood of commercial TV broadcasting. Even in its simplest form as described above, data valuable to advertisers is able to be gleaned from the received SMS messages. For example, just a total of the number of requested reminders for each programme is a direct measure generated by the prospective viewers themselves. Such totals are able to be generated by the server 17 and printed out on printer 20. This enables a better comparison of programme advertising rate relativities to be achieved, for example.

Also a direct measure of intending audiences can be gauged since it is known, for example, that there is normally a 3% audience participation rate where an opportunity is provided to enable a TV audience to vote by telephone, for example to determine the “Man of the Match” at the conclusion of a sporting event.

Furthermore, in more complex embodiments of the present invention, for the initial SMS message from a mobile phone, an immediate return SMS message can be sent acknowledging receipt of the reminder request and asking for demographic data (e.g. age, income level, etc.) of the prospective viewer that is of interest to advertisers and sponsors. This data is preferably stored separately from the message data and is able to be “mined” by the server 17 to provide a statistical analysis for intending and current advertisers. Still further, as experience with the system grows following its proposed implementation, it is envisioned that advertisers will know from the time profile of the receipt of reminder messages what the prospective ratings of a specific programme are, and how successful various programmes marketing campaigns are.

Similarly, the demographic data can be inputted into the computer if a prospective viewer registers with the system once. This data is then stored in the computer storage means and used to compile statistics by the computer operator of the viewing habits of the viewer. The data includes name, age, gender and data of birth, however, any predetermined information can be included. From the statistics, the computer operator can select registered viewers to take part in audience trials of programs or to receive advertising material from an advertiser who advertises during a television programme for which the viewer receives a reminder.

In a still further development it is proposed that the return SMS message carry advertising to the viewer wishing to be reminded. Such advertising can be in the form “This reminder of programme X is brought to you by its sponsor company Y” or in the form “This reminder is brought to you by the publishers of TV WEEK” for example. Other examples include “Don't miss the interview with actress Z of programme X in this week's TV WEEK.”

Furthermore, in the event that a proposed multimedia messaging service (MMS) is introduced, which will enable graphics and/or audio to be sent to mobile phones, the reminder and/or acknowledgement messages can include the theme music of the programme, trailer video advertising, or a commercial to be displayed during the programme, and the like.

The foregoing describes only some embodiments of the present invention and modifications, obvious to those skilled in the art, can be made thereto without departing from the scope of the present invention. For example, an immediate return SMS message can include prompts which the intending viewer follows to provide the desired G-code data.

1. A broadcast television programme reminder system for prospective viewers each having, or having access to, a mobile phone, said system comprising a computer connected to a publicly accessible telephone service and adapted to receive SMS messages from said mobile phones, each of said messages requesting a reminder regarding a television programme to be broadcast at a future time, said computer including first storage means into which at least a portion of each said message is stored, and said computer further including a message originating means connected with said first storage means and adapted to send a reply SMS message to the corresponding mobile phone a predetermined time in advance of the future broadcast start time of said television programme for which a reminder had been requested.

2. The system according to claim 1 wherein said stored portion-of said message comprises the telephone number of the originating mobile phone and a G-code or other unique numeric or alpha-numeric code which identifies the television programme for which a reminder was requested.

3. The system according to claim 2 wherein the G-code or other numeric or alpha-numeric codes are accessible to the prospective viewers from billboards, magazines, electronic media or television.

4. The system according to claim 2 or 3 wherein said SMS message includes demographic data regarding the sender of said message and said computer includes a second storage means into which said demographic data is stored.

5. The system according to claim 4 wherein said computer is adapted to analyse the data stored in said second storage means.

6. The system according to claim 1 wherein the operator of said publicly accessible telephone service charges said prospective viewer for sending said SMS message from said mobile phone and remits a portion of said charge to the operator of said computer.

7. The system according to claim 6 wherein said telephone service operator does not charge said computer operator for said reply SMS message.

8. The system according to claim 6 wherein said telephone service operator charges said prospective viewer for said reply SMS message.

9. The system according to claim 1 wherein said reply SMS message includes an advertising component.

10. The system according to claim 9 wherein said advertising component relates to a sponsor of said television show for which a reminder had been requested.

11. The system according to claims 9 or 10 wherein said advertising component relates to a published television programme guide.

12. The system according to claim 1 wherein television programs is regularly broadcast and the reply SMS message is sent at the predetermined time in advance of each broadcast of the program.

13. The system according to claim 1 wherein the prospective viewers register with the system by providing predetermined personal details, the predetermined personal details being stored in the first and second storage means.

14. The system according to claim 13 wherein the predetermined personal data is accessible to the computer operator for compiling test audience data including predetermined prospective viewers for use as part of a test audience for a proposed television program.

15. The system according to claim 1 wherein said prospective viewer uses a fixed phone line, telephones a 1900 prefix number rather than sending an SMS message and receives a recorded message via said fixed phone line instead of said reply SMS message.

16. (canceled)

17. A method of providing requested reminders to prospective viewers of a broadcast television programme each having, or having access to, a mobile phone, said system comprising the steps of:
providing a computer connected to a publicly accessible telephone service, adapting said computer to receive SMS messages from said mobile phones, each of said messages requesting a reminder regarding a television programme to be broadcast at a future time,
providing said computer with first storage means and storing therein or at least a portion of each said received message,
providing said computer with a message originating means connected with said first storage means, and sending a reply SMS message via said message originating means to said mobile phones a predetermined time in advance of the future time of said television programme for which a reminder had been requested.

18. The method according to claim 17 wherein said prospective viewer uses a fixed phone line, telephones a 1900 prefix number rather than sending an SMS message and receives a recorded message via said fixed phone line instead of said reply SMS message.

19. (canceled)
